(19) United States
(12) Patent Application Publication
(10) Pub. No.: US 2009/0113783 A1
(43) Pub. Date: May 7, 2009

(54) Fishing aid

(76) Inventor: Michael E. Hollomon, Hemphill, TX (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 11/979,659

(22) Filed: Nov. 7, 2007

(51) Int. Cl. A01K 85/01

(52) U.S. Cl. 43/42.31; 43/44.8

(57) ABSTRACT

A fishing aid including a fishhook having an eye and a barb respectively positioned at its opposed ends. A rattle is releasably secured to the fishhook. The rattle has a catch that extends from one of its opposed ends with an open-loop portion for grasping the eye of the fishhook. The rattle also has a sharpened point at the other of its opposed ends for easy insertion into a soft, plastic bait.

### FIELD OF THE INVENTION

The present invention relates generally to apparatus for fishing, trapping and vermin destroying and, more particularly, to fishing lures utilizing artificial bait having confined shifting materials that make sounds.

### BACKGROUND OF THE INVENTION

For generations, fishermen have proposed improvements to lures for attracting and catching fish. One effective lure design includes a resilient tube suspended from a single fishhook. The tube trails a number of filaments that wiggle like tentacles when retrieved. Many game fish find the sight of these filaments to be an irresistible inducement to strike, but tubes have had a tendency to slide off of conventional fishhooks thus limiting their effectiveness.

Some fishermen have taken to inserting small rattles into tubes to make sounds that travel through the water during fishing. The sounds are believed to mimic those made by injured prey and draw game fish close to a tube that they cannot initially see. Unfortunately, with only friction holding a rattle in place within a tube, a rattle will sometimes fall out and become lost when a tube bumps into a submerged object or is struck by fish. Worse yet, a rattle can shift about within a tube and prevent a fishhook from grasping a fish during a strike.

To overcome some of the problems associated with fishing with tubes, fishhooks have been produced with special clasps that penetrate the tube and provide a secondary means for holding the tube in place. Also, wire tethers have been developed for joining rattles to fishhooks. Producing lures with both tube clasps and rattle tethers is costly, and fishing with both is cumbersome.

### SUMMARY OF THE INVENTION

In light of the problems associated with the known apparatus employed to fish with resilient tubes and similar baits, it is a principal object of the invention to provide a fishing aid that securely, compactly, and simultaneously fastens both a rattle and a soft plastic bait to a fishhook. The rattle, in fact, is employed as a means of securement for the bait.

It is another object of the present invention to provide a fishing aid of the type described with a rattle that is easily inserted into a soft plastic bait regardless of whether the bait is hollow or solid in its construction. Once inserted, the rattle anchors itself strongly in place.

It is a further object of the present invention to provide a fishing aid of the type described that is easy to use and can be deployed with minimal instruction and without resort to any tools. The fishing aid is intuitive to use.

It is an additional object of the invention to provide a fishing aid that, when retrieved, has a realistic presence in the water in terms of both appearance and sound. Such a fishing aid will attract and catch more fish than lures now available. For users of the fishing aid, fishing will prove to be a more productive pastime.

It is an object of the invention to provide improved features and arrangements thereof in a fishing aid for the purposes described that is lightweight in construction, inexpensive to manufacture, and fully dependable in use.

Briefly, the fishing aid in accordance with this invention achieves the intended objects by featuring a fishhook having an eye and a barb at its opposite ends. A rattle is releasably secured to the fishhook and includes a hollow tube having opposed ends. At least one ball is loosely positioned within the tube for producing sounds when struck against the hollow tube. A cap closes one of the ends of the tube. The cap has an outwardly extending catch with an open-loop portion for grasping the eye of the fishhook. A plug closes the other one of the ends of the tube. The plug has a sharpened, conical point for easy insertion into a soft plastic bait.

The foregoing and other objects, features, and advantages of my fishing aid will become readily apparent upon further review of the following detailed description of the preferred embodiment as illustrated in the accompanying drawings.

### BRIEF DESCRIPTION OF THE DRAWINGS

My fishing aid be more readily described with reference to the accompanying drawings, in which:

FIG. 1 is a perspective view of a fishing aid in accordance with the present invention to which is attached a resilient bait with portions broken away.

FIG. 2 is a side view of the cap portion of the fishing aid with portions broken away to reveal details thereof.

FIG. 3 is an exploded perspective view of the fishing aid.

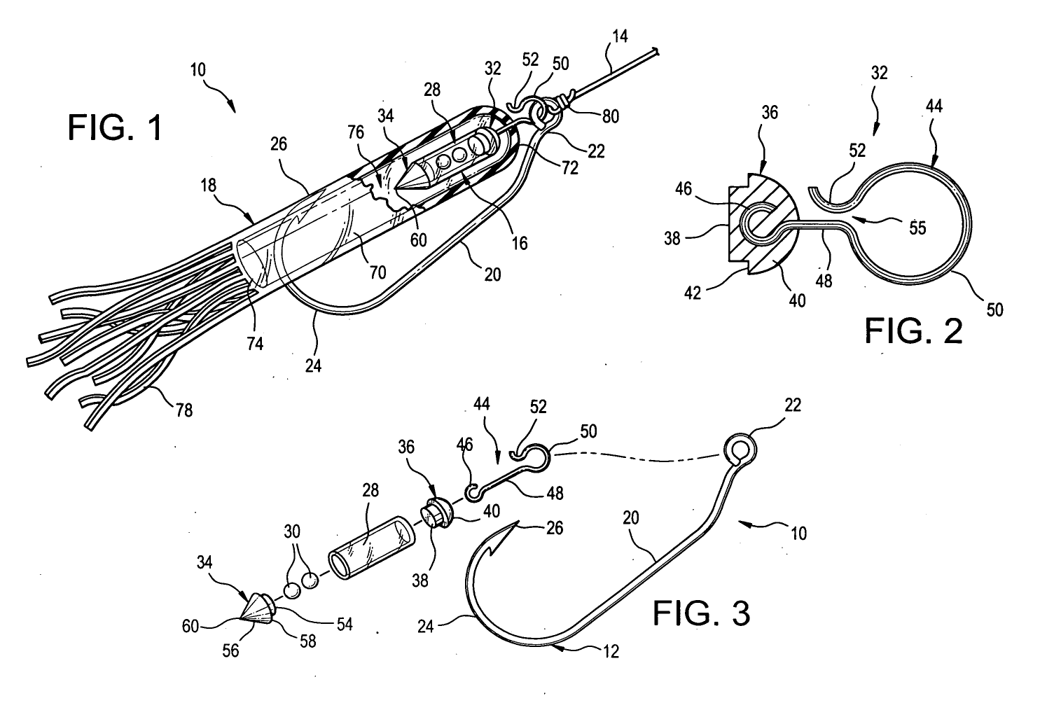

Similar reference characters denote corresponding features consistently throughout the accompanying drawings.

### DETAILED DESCRIPTION OF THE PREFERRED EMBODIMENTS

Referring now to the FIGS., a fishing aid in accordance with the present invention is shown at 10. Fishing aid 10 includes a fishhook 12 attached to the end of a flexible line 14. Carried by fishhook 12 is a rattle 16 for producing sounds that are attractive to game fish. A resilient bait 18 for visually stimulating game fish is secured to line 14 by means of fishhook 12 and rattle 16 that both penetrate bait 18 at spaced-apart points.

Fishhook 12 comprises a stiff piece of wire bent into the shape of a “J”. As shown, fishhook 12 includes an elongated shank portion 20 that comes to an end at its top in a circular eye 22 to which line 14 is tied. A catch portion 24 is integrally formed with the bottom of shank portion 20 and curves backwardly upon shank portion 20 to terminate at a free end adjacent shank portion 20. A barb 26 is formed at the free end of catch portion 24 that is capable of penetrating the mouthparts of a game fish and that points toward eye 22.

Rattle 16 includes a hollow tube 28 with opposed ends that loosely contains a number of steel balls 30 or other items capable of producing sounds when struck against the inner wall of tube 28. A cap 32 closes the top end of tube 28 to hold balls 30 in tube 28. A plug 34, however, closes the bottom end of tube 28 to retain balls 30 therein.

Cap 32 has a stopper 36 with an inner portion 38 for snug positioning within tube 28 and a somewhat larger outer portion 40 that defines a shoulder 42 at the junction of portions 38 and 40 for preventing the over-insertion of stopper 36 into tube 28. Inner portion 38 is cylindrical and has a diameter that is substantially equal to the inner diameter of tube 28. Outer portion 40, on the other hand, is dome-shaped to streamline rattle 16 and has a maximum diameter that is equal to the outer diameter of tube 28 for a flush fit with the outer wall of tube 28.

Cap 32 is provided with a catch 44 being a piece of bent wire affixed to stopper 36. As shown, catch 44 is provided with a linear stem 48 that extends from the outer portion 40 of stopper 36. The inner end of stem 48 is bent back upon itself so as to form a first loop 46 that is molded within portions 38 and 40 so as to anchor catch 44 to stopper 36. The outer end of stem 48 is similarly bent back upon itself so as to form a second loop 50 that is about three times the diameter of first loop 46. For ease of manufacture and for maximum strength loops 46 and 50 are substantially coplanar.

Second loop 50 terminates at a crook 52 for manual extension through eye 22 of fishhook 12. Crook 52 projects away from stem 48 so as to define a tapered mouth 55 for guiding eye 22 onto second loop 50. Mouth 55 is sized to receive eye 22 with a snap fit so that rattle 16 cannot be unintentionally separated from fishhook 12 once engaged. Thus, when crook 52 is passed through eye 22, mouth 55 is opened and closed in quick succession with a “snap” to grasp eye 22.

Plug 34 has an inner portion 54 for snug positioning within tube 28 and a somewhat larger outer portion 56 that defines a shoulder 58 at the junction of portions and 54 and 56 for preventing the over-insertion of plug 34 into tube 28. Preferably, inner portion 54 is cylindrical and has a maximum diameter that is equal to the inner diameter of tube 28. Outer portion 56, on the other hand, is cone-shaped, tapering in diameter from its inner end where its diameter is equal to the outer diameter of tube 28 for a flush fit with the outer wall of tube 28 to its outer end which is a sharpened point 60 for easy insertion into resilient bait 18.

Tube 28, cap 32, and plug 34 can be formed from any materials that a manufacturer finds suitable. Such materials might include plastic compounds, glass, and metal alloys that are durable and not easily corroded by prolonged exposure to water. Aluminum and lead are particularly well-suited metals since they are easily worked and are available at relatively low cost.

Resilient bait 18 includes a tube 70 molded from soft plastic or rubber and having a closed end 72 and an open end 74 that provides access to an interior cavity 76 that is large enough to contain rattle 16. Around open end 74, a number of filaments 78 extend outwardly from tube 70 to simulate tentacles that many game fish instinctively find appealing insofar as food is concerned. Bait 18, however, can take a variety of forms and can simulate animals like minnows, worms, frogs, crayfish, and salamanders, to name a few. Furthermore, bait need not be hollow and possess an interior cavity at the time of its manufacture to be used with fishing aid 10 but, rather, can be solid and possess no internal voids. If the material that a solid bait is formed from is sufficiently plastic, rattle 16 can be pressed inside with a minimum of effort with sharpened point 60 opening a cavity ahead of rattle 16.

The use of fishing aid 10 is straightforward. First, fishhook 12 is tied by a knot 80 to flexible line 14. Next, catch portion 24 of fishhook 12 is pressed through bait 18 midway between closed end 72 and open end 74 such that fishhook barb 26 rests against the side of bait 18 so as to make fishing aid 10 weedless. Then, with rattle 16 secured by means of catch 44 to fishhook eye 22, sharpened point 60 of plug 34 is pressed into the closed end of bait 18 and into cavity 76. Next, with the continued application of a light pushing force, rattle 16 is fully inserted into cavity 76. Now, fishing aid 10 can be put into a body of water in an effort to catch fish with bait 18 being firmly secured to line by both fishhook 12 and rattle 16.

Fishing aid 10 is cast and retrieved in the usual manner by means of a rod and reel (not shown). During retrieval, bait 18 can be given a wiggling action by manipulating the rod and reel to visually simulate a wounded animal that game fish find attractive. Furthermore, the wiggling of rattle 16 thrusts balls 30 against the inner wall of tube 28, cap 32, and plug 34 to produce sonic emanations that travel away from fishing aid 10 to attract fish that cannot immediately see bait 18. When a fish strikes bait 18, a tug is felt on line 14 and fishhook 12 is set in the mouth of the fish by pulling sharply on line 14. After line 14 is reeled in, the just-caught fish can be released from fishhook 12 and either set free or harvested. Use of fishing aid 10, will provide a fisherman with more opportunities to make such a choice than ever before possible.

When a fisherman has caught his limit or has otherwise decided to terminate his fishing efforts, fishing aid 10 can be detached from line 14 and placed in a tackle box for reuse at a convenient time. No further disassembly of fishing aid 10 is required as its compact size lends itself easy storage in a tackle box. Some fishermen who coat baits such as the one shown at 18 with scents and other chemical attractants may choose to detach the bait from fishhook 12 and rattle 16 by reversing the steps for attachment noted above so that the bait can be stored in a sealed container. The process of setting up fishing aid 10 for use or stowing fishing aid 10 after use requires just a few minutes to complete.

While fishing aid 10 has been described with a high degree of particularity, it will be appreciated by those skilled in the art that modifications can be made to it. Therefore, it is to be understood that the present invention is not limited merely to fishing aid 10, but encompasses any and all fishing aids within the scope of the following claims.

I claim:

1. A fishing aid, comprising:
a fishhook having first opposed ends and an eye at one of said first opposed ends and a barb at the other of said first opposed ends; and,
a rattle being releasably secured to said fishhook, said rattle including:
a hollow tube having second opposed ends;
a plurality of balls being loosely positioned within said hollow tube for producing sounds when struck against said hollow tube;
a cap closing one of said second opposed ends of said hollow tube, said cap including:
a stopper having an inner portion snugly positioned within said hollow tube and an outer portion positioned outside said hollow tube and in abutment with one of second opposed ends;
a wire catch being affixed to said stopper, said catch including a linear stem extending from said outer portion of said stopper, said stem having an inner end and an outer end, said inner end of said stem being formed into a first loop being molded within both said inner portion of said stopper and said outer portion of said stopper, said outer end of said stem being bent back upon itself so as to form a second loop that is substantially coplanar with said first loop, said second loop terminating at a crook projecting away from said stem so as to define a tapered mouth for guiding said eye onto said second loop with a snap fit; and,
a conical plug closing the other one of said second opposed ends of said hollow tube, said plug having a sharpened point for easy insertion into a soft plastic bait.

2. A rattle for use with a fishhook having first opposed ends and an eye at one of said first opposed ends and a barb at the other of said first opposed ends, said rattle comprising:
a hollow tube having second opposed ends;
at least one ball being loosely positioned within said hollow tube for producing sounds when struck against said hollow tube;
a cap closing one of said second opposed ends of said hollow tube, said cap including:
a stopper having an inner portion snugly positioned within said hollow tube and an outer portion positioned outside said hollow tube and in abutment with one of second opposed ends;
a wire catch being affixed to said stopper, said catch including a linear stem extending from said outer portion of said stopper, said stem having an inner end and an outer end, said inner end of said stem being formed into a first loop being molded within both said inner portion of said stopper and said outer portion of said stopper, said outer end of said stem being bent back upon itself so as to form a second loop that is substantially coplanar with said first loop, said second loop terminating at a crook projecting away from said stem so as to define a tapered mouth for guiding said eye onto said second loop with a snap fit; and,
a conical plug closing the other one of said second opposed ends of said hollow tube, said plug having a sharpened point for easy insertion into a soft plastic bait suspended from the fishhook.
